(19) United States
(12) Patent Application Publication
(10) Pub. No.: US 2008/0240884 A1
(43) Pub. Date: Oct. 2, 2008

(54) Locking device

(76) Inventor: Laurence E. Dahners, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 11/728,968

(22) Filed: Mar. 27, 2007

(51) Int. Cl. F16B 39/00

(52) U.S. Cl. 411/190

(57) ABSTRACT

A locking device is provided that includes a nut having a body portion and an end portion. The end portion has a proximal end proximate to the body portion and a distal end. The nut has an inner surface defining a nut aperture that extends through the body portion and the end portion with the inner surface of the nut being at least partially threaded. The locking device also includes a bolt having a head and a body. The head of the bolt defines a head aperture therein that extends into the body of the bolt. The body of the bolt is at least partially threaded to matingly engage the threaded inner surface of the nut. The body also defines at least one slot therein that is in communication with the head aperture. Slats are disposed along the distal end of the end portion of the nut. The slats are configured to engage the at least one slot defined in the body of the bolt.

### TECHNICAL FIELD

The subject matter described herein relates generally to locking devices. More particularly, the subject matter discloses herein relates to locking nuts and bolts and locking devices which employ such nuts and bolts.

### BACKGROUND

Locking devices which employ bolts and nuts commonly use mechanisms that prevent a nut or some other component from working loose from the bolt unintentionally. Further, locking devices can be used to prevent unauthorized loosening of such components by unintended users.

Locking nuts are generally used when there is any concern about fastening devices working loose over time. For example, locking nuts can be used on parts of a machine that spins. Bicycles, wheels on axles, pipes, sanders, and grinders, all use locking nuts of some kind. In the context of power transmission, locking nuts are used to securely fasten gears and bearings to shafts and spindles.

An example of a locking nut is a castellated nut. Castellated nuts are nuts designed to be used with carter pins. The bolt onto which such a nut is threaded can have a hole drilled through it and the nut is turned so that its castellations line up with the hole before a carter pin is installed. The carter pin then locks the nut in place by preventing it from turning.

Nyloc nuts are another example of locking nuts used to prevent loosing of the fastening devices during use. The nyloc is a nut that includes a ring of nylon inside the thread. The nyloc nut is design to increase locking forces and prevent the nut from coming loose through friction created by the locking nut. The nylon ring has no threads cut into it. It is forced to form around the threads of the bolt on which it is twisted. In most applications, a nyloc nut cannot be reused after being removed.

For fluid fittings and the like, the most common method of preventing a nut from loosening from a bolt is through the use a safety wire. A length of stainless steel wire is attached to the nut of the fluid coupling via a small hole. The other end of the wire is tied to a nearby component such that nut rotation in the loosening direction is resisted by the wire.

Another conventional device is a Moeller fitting, which provides torque resistance to the nut by positioning a pattern of torque “bumps” along the male end of the coupling and corresponding recesses positioned along the interior surface of the nut to receive these bumps when mating the male and female halves. Such a system requires that both the male and female coupling components conform to a specific design and both the male and female halves must be replaced upon removal of the fastening device.

Other locking mechanisms which create frictional engagements include products such as locking washers, screw binders, spring washers, prevailing torque threads, form threads, plastic thread inserts, and double bash nutting. Other locking mechanisms which require a further component to lock the nut to the bolt include anaerobic adhesives and locking pins.

Many of these locking mechanisms do not achieve their intended results. For example, the devices which use a friction fit do not actually lock the screw in place so that it cannot be unscrewed. Other devices which use ratchet type locks are not easily undone when a need develops to unscrew the device. Other systems involve placing other screws or devices in the bolt or nut, such as a carter pin or safety wire, that lock the nut in place so that it cannot be unscrewed. However, such devices are time-consuming due to the fact that they require an additional device or component to be attached to the bolt and/or nut and usually require skill and dexterity in placement of the secondary device in its correct position.

Therefore, a need exists for a locking device which can lock together to prevent the decoupling of the locking device except through the use of a proper driver mechanism with the locking device being reusable.

### SUMMARY

In accordance with this disclosure, locking device systems for securing objects together are provided.

A principal purpose of the present disclosure therefore is to provide a locking device that may be secured together after engagement of the bolt element to the nut element preventing unintentional decoupling of the nut element from the bolt element while at the same time permitting disengagement of the bolt element from the nut element through the use of a proper driver mechanism. This and other purposes as may become apparent either in whole or in part from presently disclosed subject matter will become evident as the description proceeds when taken in connection with the accompany drawings as best described here and below.

### BRIEF DESCRIPTION OF THE DRAWINGS

A full and enabling disclosure of the present subject matter including the best mode thereof to one of ordinary skill in the art is set forth more particularly in the remainder of the specification including references to the accompanying figures in which:

FIG. 1 illustrates a perspective view of an embodiment of a locking device according to the present subject matter;

FIG. 2 illustrates a perspective view of the embodiment of a locking device according to FIG. 1 with the bolt element coupled to the nut element;

FIG. 3 illustrates a perspective view of a nut element for the embodiment of a locking device according to FIG. 1;

FIG. 4 illustrates a vertical cross-sectional view of a nut element for the embodiment of a locking device according to FIG. 1;

FIG. 5 illustrates a vertical cross-sectional view of a bolt element for the embodiment of a locking device according to FIG. 1;

FIG. 6 illustrates a bottom plan view of a bolt element for the embodiment of a locking device according to FIG. 1;

FIG. 7A illustrates a side view of a portion of an embodiment of a driver device that can be used in a locking device according to the present subject matter;

FIG. 7B illustrates a bottom plan view of the driver device according to FIG. 7A;

FIG. 8 illustrates a vertical cross-sectional perspective view of the embodiment of a locking device according to FIG. 1 with the bolt element coupled to the nut element;

FIG. 9 illustrates a perspective view of the embodiment of a locking device engaged by a driver device according to FIG. 1;

FIG. 10 illustrates a vertical cross-sectional perspective view of the embodiment of a locking device engaged by a driver device according to FIG. 1; and

FIG. 11 illustrates a vertical cross-sectional perspective view of the embodiment of a locking device engaged by a driver device and holding two objects together according to FIG. 1.

### DETAILED DESCRIPTION

Reference will now be made in detail to the present preferred embodiments of the present subject matter, one or more examples of which are shown in the Figures. Each example is provided to explain the subject matter and not as limitation. Features illustrated or described as part of one embodiment can be used in another embodiment to yield still a further embodiment. It is intended that the present subject matter covers such modifications and variations.

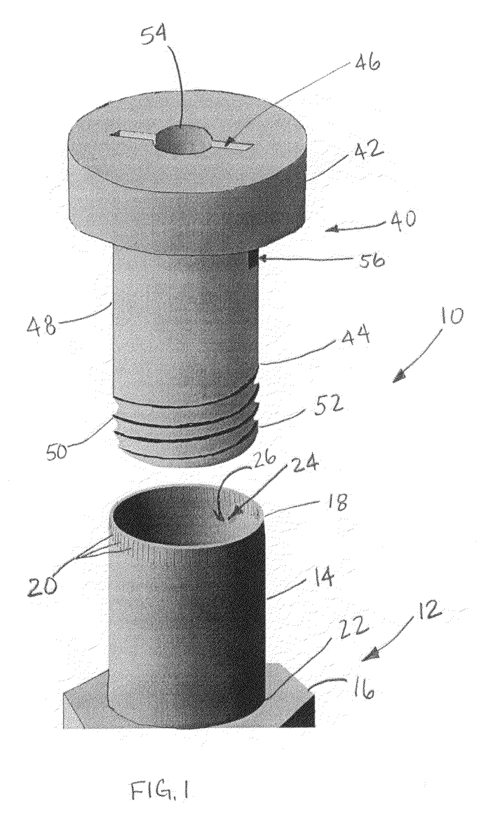

FIG. 1 illustrates a locking device, generally designated as 10, which can be used to secure two objects together while preventing detachment of the elements of the locking device as well as the objects from one another. The locking device includes a nut element 12 having an end portion 14 and a body portion 16. End portion 14 has a distal end 18 which has slats 20 disposed therein. End portion 14 has a proximal end 22, which is adjoined to the body portion 16. Nut element 12 has a nut aperture 24, which passes through end portion 14 and body portion 16. Nut aperture 24 is defined by an inner surface 26 which also extends through end portion 14 and body portion 16. At least a portion of inner surface 26 of nut element 12 is threaded.

Locking device 10 also includes a bolt element 40. Bolt element 40 can include a head 42 and a body 44. Head 42 includes a head aperture 46 that extends into body 44 of bolt element 40. Body 44 can be at least partially threaded to matingly engage an at least partially threaded inner surface 26 of nut element 12. Body 44 of bolt element 40 can include a first segment 48 which can be unthreaded. Threads 50 can be included on a second segment 52 of body 44 of bolt element 40. The first segment 48 of body 44 may be integral to head 42 of bolt element 40 with head aperture 46 extending into first segment 48.

“Nut element” as used herein can be any structure which is configured to receive a bolt element. “Bolt element” as used herein can be any structure which can engage a nut element. The nut element and the bolt element can be threaded or unthreaded. The nut element should include at least one slat, while the bolt element should include at least one roughened surface, such as a slot, that can be engaged by the at least one slat of the nut element and capable of receiving a driver device that can disengage the at least one slat from the bolt element. Such nut element and bolt element can be used, for example, as a lock and key mechanism, an axle connection, or other secure engagement. The nut element can be in the form of a threaded nut and the bolt element can be in the form of a threaded bolt.

Head 42 with head aperture 46 can further define a guide lock entry 54. Guide lock entry 54 can be used to center a driver device and also prevent unwanted detachment of bolt element 40 from nut element 12.

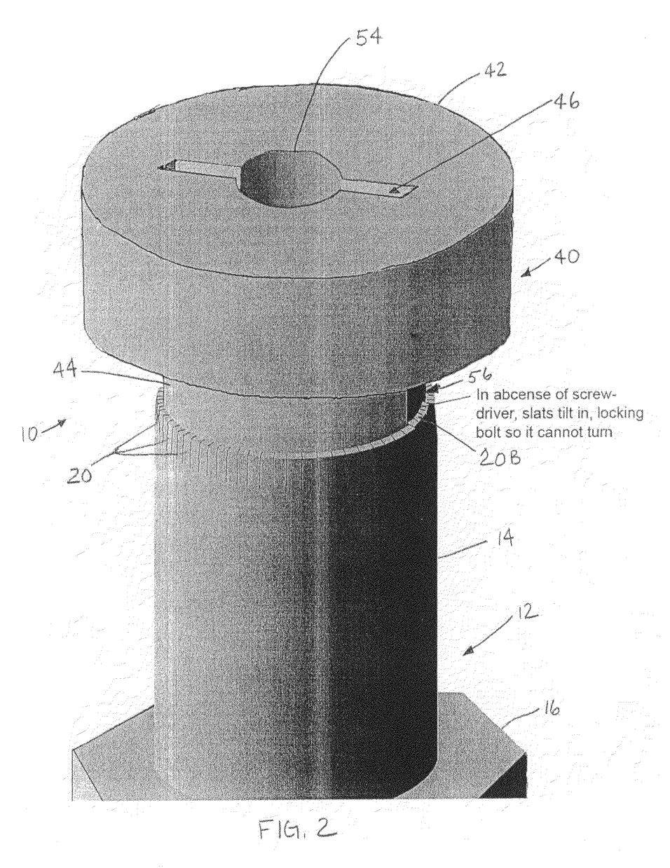

As seen in FIGS. 1 and 2, bolt element 40 may include at least one slot 56 defined within body 44. Slot 56 is in communication with head aperture 46. As shown in FIG. 1, slats 20 at distal end 18 of end portion 14 are slanted inward toward nut aperture 24. In use, bolt element 40 can be inserted into nut aperture 24 with a portion of body 44 of bolt element 40 extending slats 20 outward into a more parallel alignment with the rest of end portion 14. In particular, the portion of body 44 which contains slot 56 can have a diameter which effectively extends the previously inward slanting slats 20 to a more parallel alignment with end portion 14 as seen in FIG. 2.

Due to the memory and resiliency of slats 20, these slats 20 resume their inward slant once the forces defecting slats 20 outward are removed. For example, once the driver device used to screw the bolt elements 40 into nut element 12 is removed from head aperture 46 and slot 56, slats, designated as 20B, aligned with slot 56 will return to their inward slanting position thereby extending into the slot 56 of bolt element 40. These slats 20B prevent rotation of bolt element 40 in either direction due to the contact of these inward slanting slats 20B with the walls forming slot 56 within bolt element 40.

The inward slant can be measured from the inside of the slats, since slats 20 may have different thicknesses than the rest of end portion 14 depending upon the design of the slats and the material used. For example, the slats 20 can be thinner or thicker at specific points thereon than the end portion 14 or even other portions of the slats 20.

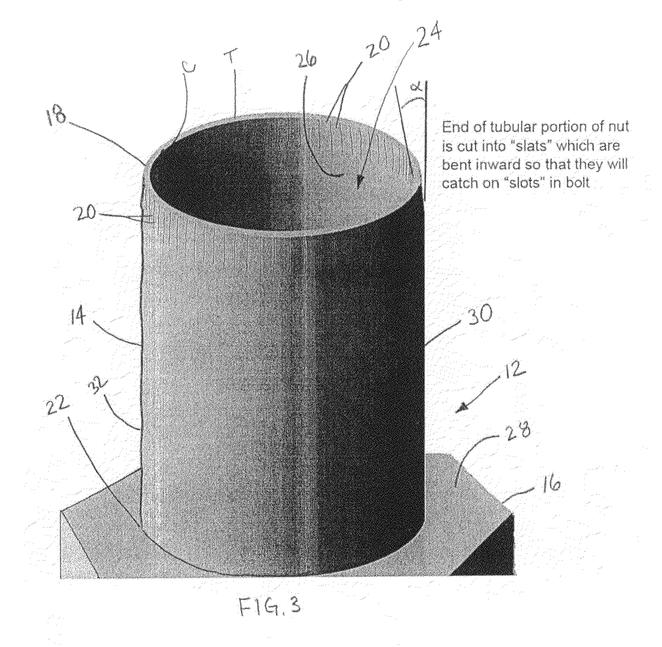

A perspective of an embodiment of nut element 12 is shown in FIG. 3. Body portion 16 of nut element 12 has a larger width and depth than end portion 14 thereby creating a shelf 28. In the embodiment shown, body portion 16 of nut element 12 has a hexagonal shape which permits the holding of nut element 12 through devices such as sockets, wrenches, pliers, or the like during placement, insertion, and engagement of bolt element 40 within nut element 12. The shape of body portion 16, however, can take on many forms, including square, rectangular, octagonal, circular, non-symmetrical, or the like. Further, body portion 16 may have a slot formed therein on its bottom side which permits a screwdriver or the like to be inserted therein to prevent rotation of nut element 12 during insertion and engagement of bolt element 40 within nut element 12.

End portion 14 having proximal end 22 integral with body portion 16 of nut element 12 may have a tubular cross-section as shown in FIG. 3. End portion 14 can include sleeve 30 between proximal end 22 and slats 20 at distal end 18. Sleeve 30 can have an outer surface 32. Outer surface 32 of sleeve 30 can comprise other cross-sectional shapes, such as hexagonal, square, rectangular, octagonal, non-symmetrical, or the like, that may help to prevent rotation of nut element 12 when inserted through an aperture having a matching feature to that of the outer surface 32. Sleeve 30 of end portion 14 may, of course, have a circular cross-sectional shape as shown in the figures to allow rotation of nut element 12 once inserted through the apertures within the objects to be held by the locking device 10.

Distal end 18 with slats 20 defined therein can have a circular cross-section and may be of a thickness of material that permits the bending of the slats 20 inward and allow slats 20 to be resilient and contain a memory to allow them to return to their inward slanting position after deformation. The slant of slats 20 may be at an angle α which permits vertical insertion of bolt element 40 into nut aperture 24 such that a portion of body 44 of bolt element 40 can push slats 20 outward from nut aperture 24 such that the inner surface of slats 20 more closely align with the rest of inner surface 26 of nut element 12. Angle α can be measured from the outside surface at the base of the slat 20 to the furthest point of the slat 20 that extends into nut aperture 24. In the embodiment shown, such a point of each slat would be inner corner C at top T of each slat 20.

An angle α that is too great would likely cause the slats to bend inward toward nut aperture 24 when inserting bolt element 40. Having too small of an angle α at which the slats are bent may not prevent rotation of bolt element 40 once slats 20 enter slot 56 of body 44. Thus, angle α needs to be at an angle that allows insertion of the bolt element, but still prevent rotation of the bolt element once slats 20 enter slot 56.

Nut element 12 may be made of material such as metals or plastics of adequate strength to hold objects together when bolt element 40 is secured within nut element 12 and at the same time provide necessary resiliency to slats 20 formed at distal end 18 of end portion 14 of nut element 12. Nut element 12 and bolt 40 can be made from a variety of different materials including but not limited to metals and/or plastics. In some embodiments, end portion 14 can be constructed of a different material than body portion 16 of nut element 12. In such case, at least the material forming end portion 14 should possess resilient characteristics to allow slats 20 to have proper memory to aid in locking bolt element 40 to nut element 12. Similarly, the thickness of distal end 18 of end portion 14, and thereby slats 20, should be of a thickness which permit resiliency of the slats depending on the type of material used to form end portion 14.

To form slats 20, distal end 18 of end portion 14 can be cut at specific distances. For example, slats 20 may have a uniform width. The width of slats 20 should be such that it permits at least one slat to enter into slot 56 wherever rotation is stopped and the screwdriver is removed after bolt element 40 is sufficiently secured within nut element 12. The cuts to form slats 20 can be performed before or after distal end 18 is bent to provide slats 20 with a sufficient angle α. In other embodiments, slats 20 can be formed during molding of nut element 12. In addition, different thicknesses along each slat 20 can be formed during the molding process.

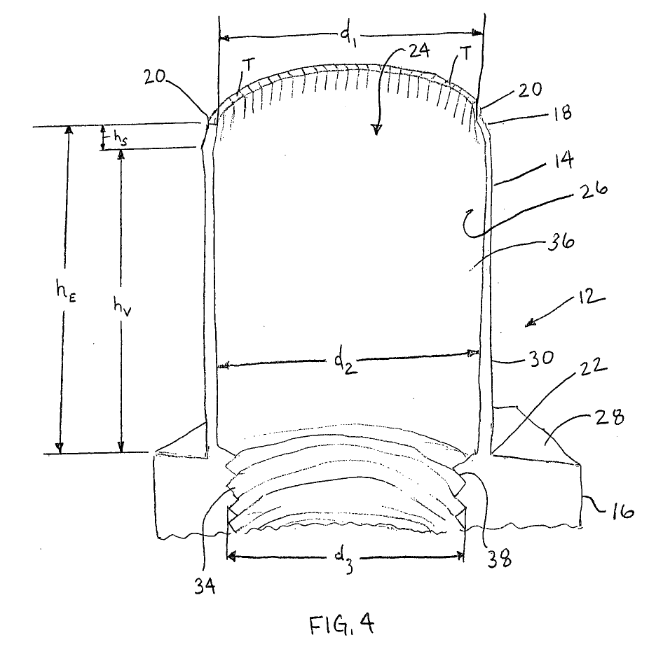

FIG. 4 illustrates a vertical cross-sectional view of nut element 12. At least a portion of inner surface 26 which defines nut aperture 24 is illustrated. Inner surface 24 has a circular cross-section throughout to permit rotational engagement of bolt element 40 with nut element 12. Inner surface 26 defines threads 34 in at least a portion therein to permit threaded engagement of bolt element 40 with nut element 12. Thus, threads 50 of bolt element 40 and threads 34 of nut 12 may be of substantially similar pitch and lead to permit matching engagement.

Inner surface 26 may have a first section 36 which can provide a substantially smooth surface that extends up to distal end 18 of end portion 14. A second section 38 of inner surface 26 may contain threads 34 therein. In the embodiment shown in FIG. 4, second section 38 of inner surface 26 begins in body portion 16 of nut element 12, while first section 36 of inner surface 26 resides in end portion 14. However, second section 38 can extend into end portion 14. Conversely, substantially smooth first section 36 of inner surface 26 may extend into body portion 16.

As shown in FIG. 4, nut aperture 24 can possess different diameters at different locations within nut element 12. For example, nut aperture 24 at distal end 18 may have a diameter d₁ as measured from the farthest inwardly extending points of slats 20. In the embodiment shown, such points occur at tops T of slats 20. A portion of nut aperture 24 defined by first section 36 of inner surface 26 can have a second diameter d_{2.} Diameter d₁ of nut aperture 24 measured at slats 20 can be a smaller measurement than diameter d₂ of nut aperture 24 measured in first section 36 of inner surface 26.

Nut aperture 24 may have a diameter d₃ located in second section 38 of inner surface 26 as measured from the inner grooves of threads 34. Diameter d₃ of second section 38 of inner surface 26 may be smaller in measurement than diameter d₂ of first section 36 of inner surface 26. Further, diameter d₃ of nut aperture 24 within second section 38 may have a smaller measurement than diameter d₁ of nut aperture 24 as measured at the top of slats 20.

End portion 14 may have a height h_{E} that comprises a sleeve height h_{V} and slat height h_{S}. Height h_{E} of end portion 14 can depend upon the thickness of the items or objects which are being secured together through bolt element 40 and nut element 12 of locking device 10. Generally, a larger height h_{E} of end portion 14 translates into a larger height h_{V} of sleeve 30. While the height h_{S} of slats 20 may vary, such height should not change to a point where slats 20 would no longer serve effectively as locking elements between nut element 12 and bolt element 40. In some embodiments, sleeve 30 may be eliminated such that slats 20 begin at proximal end 22 of end portion 14. In such embodiments, only slats 20 extend upward from body portion 16 to form end portion 14.

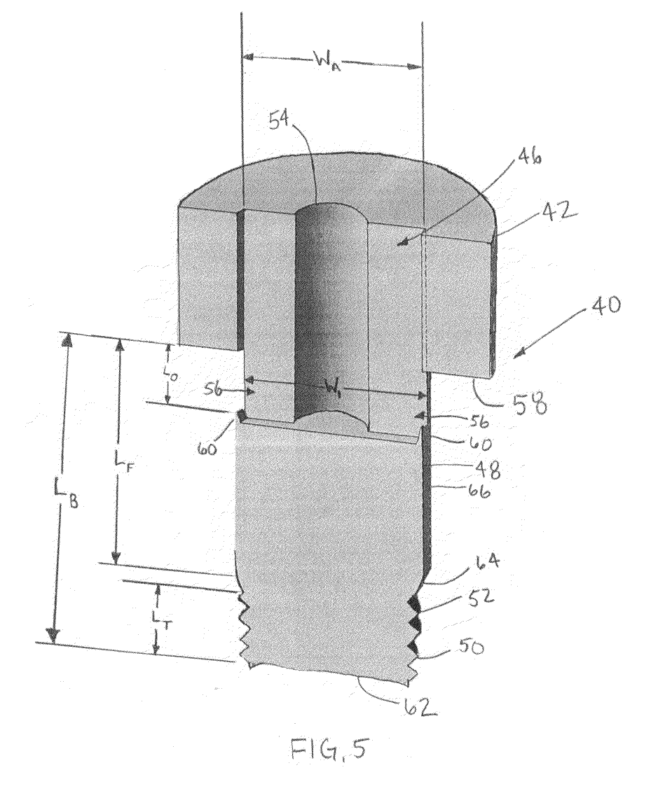

FIG. 5 illustrates a cross-sectional view of bolt element 40 in which head aperture 46 is defined. Head 42 of bolt element 40 extends outward past body 44 of bolt element 40 to create a shelf 58 that can be used to secure the objects together when bolt element 40 is engaged with nut element 12 such that the objects being secured together are held between shelf 58 of bolt element 40 and shelf 28 of nut element 12.

Head aperture 46 can have a width W_{A} which can be the same width as a width W₁ of first segment 48 of bolt element 40. In this manner, slots 56 are formed on both sides of body 44 within first segment 48. Moreover, width W_{A} of head aperture 46 may be larger to permit insertion of a specially designed driver that has a larger width to fit a head portion and a smaller width to fit within the body portion of the head aperture 46. Further, width W_{A} of head aperture 46 may be smaller in measurement than width W₁ of body 44. In such an embodiment, head aperture 46 may be off centered so that it is in communication with a single slot 56 formed in first segment 48 of body 44 of bolt element 40.

Guide lock entry 54 is centered within head aperture 46 in the embodiment shown. Guide lock entry 54 may be concave or convex on either side of head aperture 46. Further, guide lock entry 54 may have other cross-sectional shapes such as hexagonal, octagonal, non-symmetrical, or the like. Guide lock entry 54 can be used to ensure only authorized attachment and detachment of bolt element 40 to nut element 12 occurs by requiring a specially designed driver which matches the feature of the guide lock entry 54 as will be discussed in greater detail below.

Head aperture 46 can extend farther into body 44 past slots 56 so as to form lips 60 below slots 56. Lips 60 can also be useful in ensuring that bolt element 40 can be easily removed using a proper driver device when unscrewing bolt element 40 from nut element 12.

Second segment 52 of body 44 as discussed above may have threads 50 disposed thereon to engage threaded portion of nut element 12. Body 44 can have a length L_{B} which is longer than the total height of nut element 12 such that an end 62 of bolt element 40 may extend through nut element 12. Conversely, length L_{B} of bolt element 40 can be about equal to or smaller than the height of nut element 12 such that when bolt element 40 is fully engaged, end 62 of bolt element 40 does not extend outward of nut aperture 24. Second segment 52 of body 44 can have length L_{T} which may be greater than or less than the threaded portion of nut element 12. Further, slot 56 may have a length L_{O}. Length L_{O} of slots 56 may vary between different bolt elements 40 depending on the intended use of the locking device. Further, length L_{O} may vary from slot to slot within a bolt element to enhance the need of a specialized tool to disengage bolt element 40 from nut element 12. The length L_{O} of slot 56 can also vary depending on the need of adjustability of the bolt element within nut element 12. By providing a larger length L_{O} of slot 56, objects having a larger range of thicknesses can be secured by bolt elements having the same design characteristics. Thus, a single bolt element can be used in various applications to secure various objects of different thicknesses together.

Similarly, length L_{F} of first segment 48 of body 44 may vary depending on the use and need of the bolt element 40. Between first segment 48 and second segment 52 of body 44, a sloped surface 64 may reside. The sloped surface 64 may have a gradual gradient which aids in extending slats 20 outward from their inward slant when inserting bolt element 40 into nut element 12.

Head aperture 46 can also include a third or fourth slit which extends outward from a center of the aperture that can be, for example, perpendicular to width W_{A}. These third or fourth slits can be in communication with corresponding slots 56 within first segment 48 of bolt element 40 to further enhance the need of a special driver mechanism to engage and disengage bolt element 40 from nut element 12.

End 62 of body 44 may be concave as shown in FIG. 5. Further, end 62 of bolt element 40 may be convex or pointed, such as with a screw, depending on the use of bolt element 40.

A multitude of different bolts with variously shaped slots, head apertures, and/or guide lock entries requiring a variety of different driver devices which can serve as “keys” in preventing disassembly by unauthorized persons can be manufactured and are contemplated by this application.

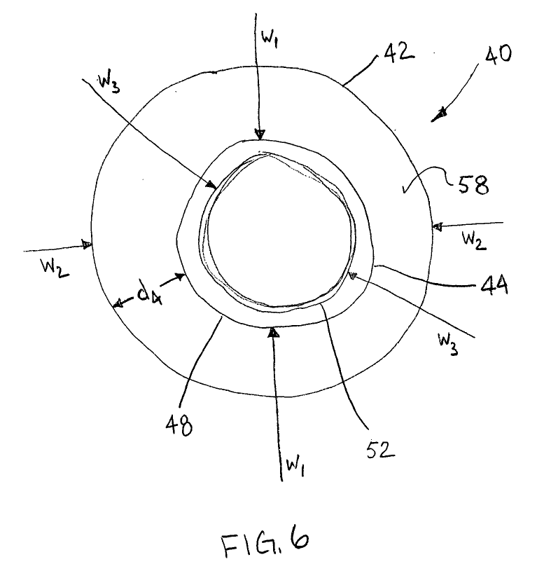

FIG. 6 shows a bottom plan view of bolt element 40 that illustrates the different widths within bolt element 40. The head 42 of bolt element 40 may have a width W₂ which is greater than width W₁ of first segment 48 of body 44. This differential creates shelf 58 of bolt element 40. In the embodiment shown, shelf 58 has a width d₄ between the end of head 42 to first segment 48 of body 44. Width d₄ is great enough to aid in securing the objects together in which the locking device 10 is placed. The end view shows head 42 to have a circular cross-sectional shape. Such a cross-sectional shape of head 42, however, can take on many forms, including square, rectangular, octagonal, hexagonal, non-symmetrical, or the like.

Comparing FIG. 4 and FIG. 6, second segment 52 of body 44 has a width W₃ which is smaller than width W₁ of first segment 48 of body 44. In use, width W₃ of second segment 52 of body 44 as measured from threads 50 should be substantially similar to diameter d₃ of nut aperture 24 within second section 38 of inner surface 26. Similarly, width W₁ of first segment 48 of body 44 can have a substantially similar measurement to diameter d₂ of nut aperture 24 within first segment 36 of inner surface 26.

Since width W₃ of second segment 52 of body 44 is similar in measurement to diameter d₃ of second section 38 of inner surface 26, width W₃ can be smaller in measurement than diameter d₁ of nut aperture 24 as measured at the top of slats 20. Thus, second segment 52 of body 44 of bolt element 40 can pass through diameter d₁ of nut aperture 24 as measured at slats 20 without much difficulty due to the fact that width W₃ should be smaller in measurement than diameter d₁ of nut aperture 24. As bolt element 40 is inserted farther into nut element 12, sloped surface 64 as seen in FIG. 5 should aid in extending slats 20 outward to allow bolt element 40 to engage nut element 12. First segment 48 of body 44 extends slats 20 farther to their furthest extending position during rotation of bolt element 40 as threads 50 of second segment 52 of body 44 engage threads 34 of second section 38 within nut element 12. Through the use of a driver device which occupies slots 56 during insertion and engagement of bolt element 40 into nut element 12, bolt element 40 can be tightened to nut element 12 to the point where the distal end 18 contacts head 42 of bolt element 40 or threads 50 of bolt element 40 are fully tightened in threads 34 of nut element 12.

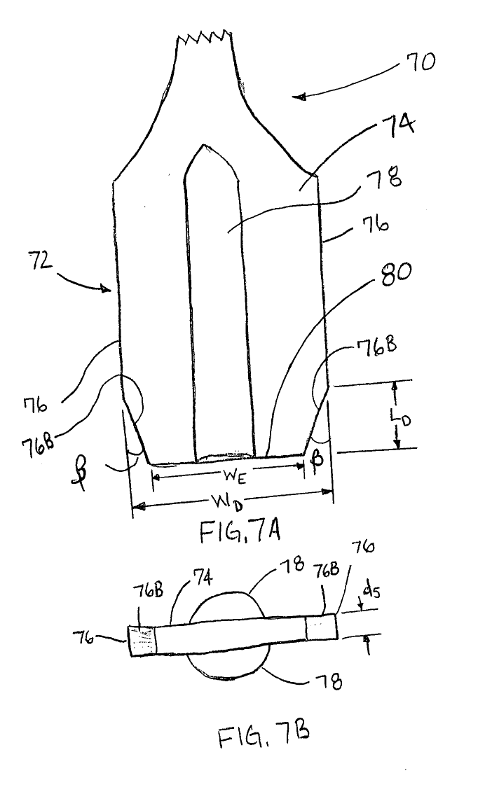

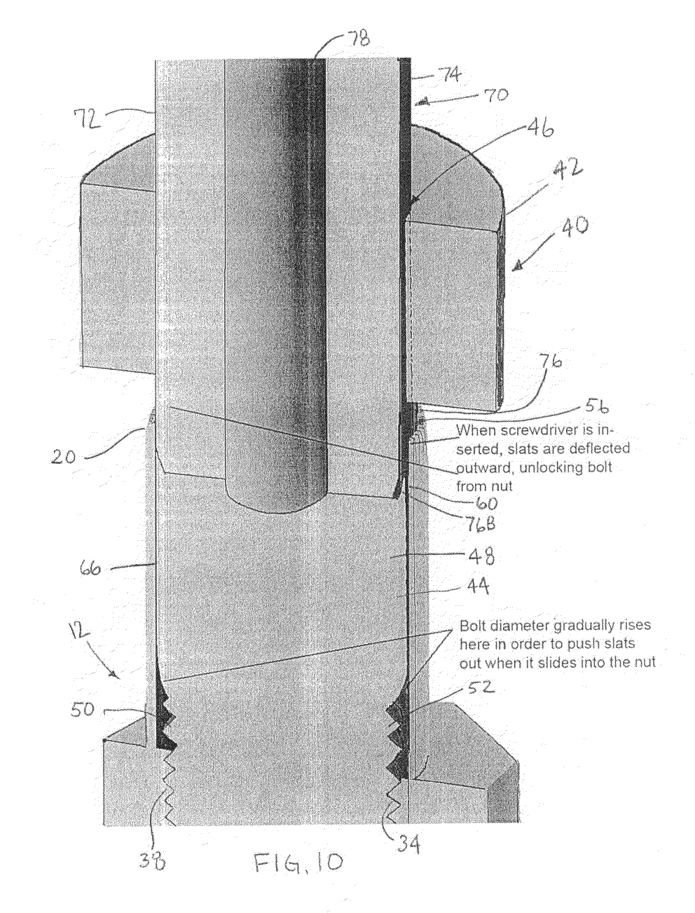

FIGS. 7A and 7B illustrate a portion of a driver device, generally designated as 70, that can be used to screw bolt element 40 into nut element 12 as shown in FIG. 2. Driver device 70 includes head 72 for insertion into head aperture 46 of head 42 of bolt element 40. Head 72 includes driver plate 74 having a width W_{D} as measured from sides 76. Width W_{D} corresponds to width W_{A} of head aperture 46 and the width of slots 56 in bolt element 40. Driver plate 74 also has the depth d₅ as measured at sides 76 that generally correspond to the depth of slots 56. Thereby, driver plate 74 of head 72 occupies slots 56 so that sides 76 are generally flush with outer surface 66 of first segment 48 of body 44 of bolt element 40 (see FIGS. 5 and 10). Head 72 further includes a guide key 78 that is in the shape of a matching feature for guide lock entry 54 within head 42 of bolt element 40. For example, guide key 78 can be convex to match a concave guide lock entry key or concave to match a convex guide lock entry. Similarly, guide key 78 and guide lock entry 54 may include a series of matching detents and indentions to further limit the number of driver devices that may be used to engage and disengage bolt element 40 from nut element 12. Further, in some embodiments, neither a guide key 78 nor a guide lock entry 54 may be present on either the driver device 70 and within head 42 of bolt element 40, respectively.

In the embodiment shown in FIGS. 7A and 7B, head 72 has an end 80 that has a width W_{E} which is smaller then width W_{D} of drive plate 74. Width W_{E} of end 80 of head 72 can be less than diameter d₁ of aperture 24 as measured at the top of slats 20. In this manner, when head 72 of driver device 70 is inserted into head aperture 46 of a bolt element 40 that is engaged in a nut element 12 (as shown in FIG. 2), width W_{E} of end 80 can pass by the slats 20B which reside within slots 56 when unscrewing the bolt element 40 from the nut element 12.

Sides 76B of driver plate 74 extend down to end 80 at an angle β. Angle β is such that once the end 80 is placed in nut aperture 24, driver plate 74 gradually pushes slats 20 which extend into slots 56 of bolt element 40 gradually outward until they reside against sides 76 of driver plate 74. Angle β should be great enough to not cause slats 20 to bend farther inward in slots 56 of bolt element 40 when inserting head 72 of driver device 70 into nut aperture 24 to disengage bolt element 40. Further, Angle β should allow head 72 to fully extend slats 20 outward over a limited available depth to permit unscrewing of bolt element 40 from nut element 12.

Head 72 can take on other embodiments which match the necessary design of the different possible head apertures and bolt designs discussed above. Thus, specific driver devices 70 can be designed with specific heads to match specific bolt and nut arrangements to further limit unauthorized decoupling of such bolt and nut arrangements.

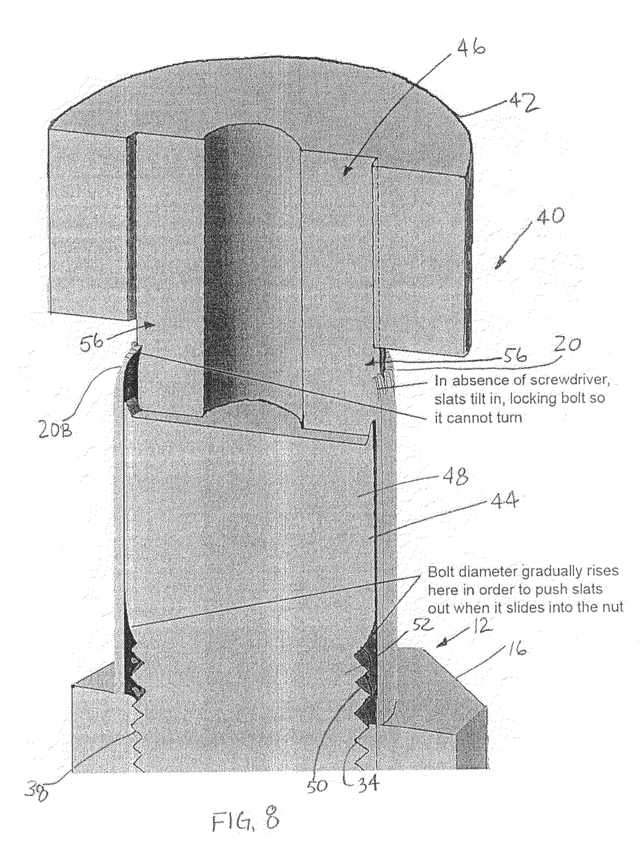

FIG. 8 shows a cross-sectional view of a bolt element 40 engaging a nut element 12 after the driver device has been withdrawn from head aperture 46 within head 42 of bolt element 40. The depth of slots 56 permits multiple slats 20 to bend inward into the slots 56 thereby preventing further rotation of bolt element 40 within nut element 12. Threads 50 within second segment 52 of body 44 engage threads 34 within second section 38 of body portion 16 of nut element 12 to prevent axial movement of bolt element 40 within nut element 12. In this way, bolt element 40 and nut element 12 are secured together in a manner that will prevent unintentional disengagement of bolt element 40 from nut element 12.

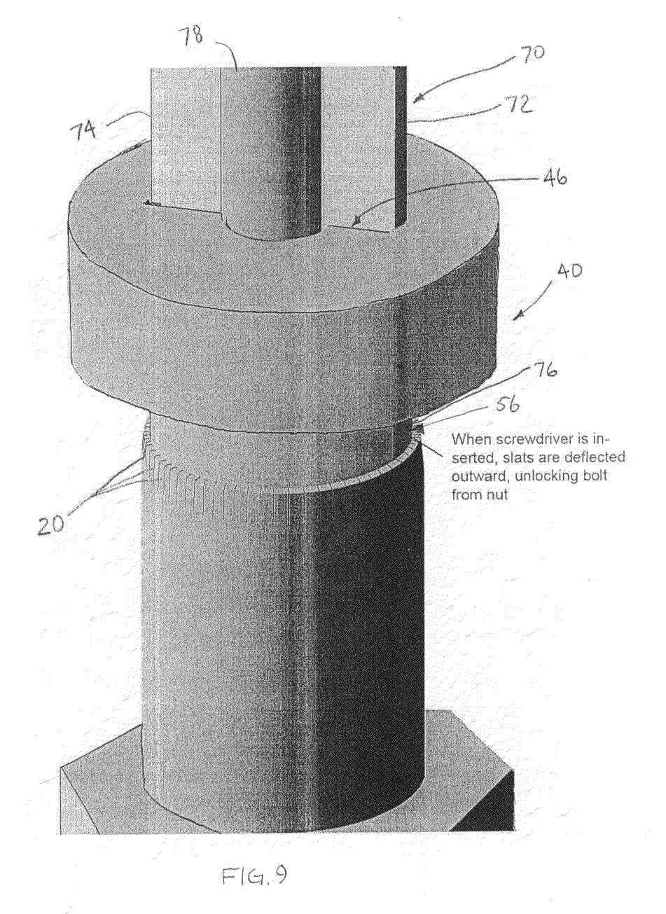

To unscrew bolt element 40 from nut element 12, driver head 72 of driver device 70 can be inserted though head aperture 46 of head 42 such that sides 76 and 76B of driver head 72 of the driver device 70 push slats 20 that were once extending into slots 56 outward into alignment with the other slats 20 around distal end 18 of end portion 14 of nut element 12 to permit rotation of the bolt element 40 within the nut element 12 as shown in FIGS. 9 and 10. The slanted sides 76B push slats 20 outward as head 72 is inserted through head aperture 46. These slanted sides 76B of head 72 come to rest against lip 60 below slots 56 within first segment 48 of body 44 of bolt element 40 so that the side 76 of driver head 72 are flush with outer surface 66 of first segment 48 of body 44 of bolt element 40. This permits seamless unscrewing or screwing of bolt element 40 into nut element 12 without the slats bending inward to catch on the exposed opening between head 72 and bolt element 40 within slot 56.

In this manner, the driver device 70 unlocks bolt element 40 from nut element 12. Thus, when locking device 10 is used to secure objects or items together, bolt element 40 can be tightened within nut element 12 to ensure that the items are tightly secured together and inseparable.

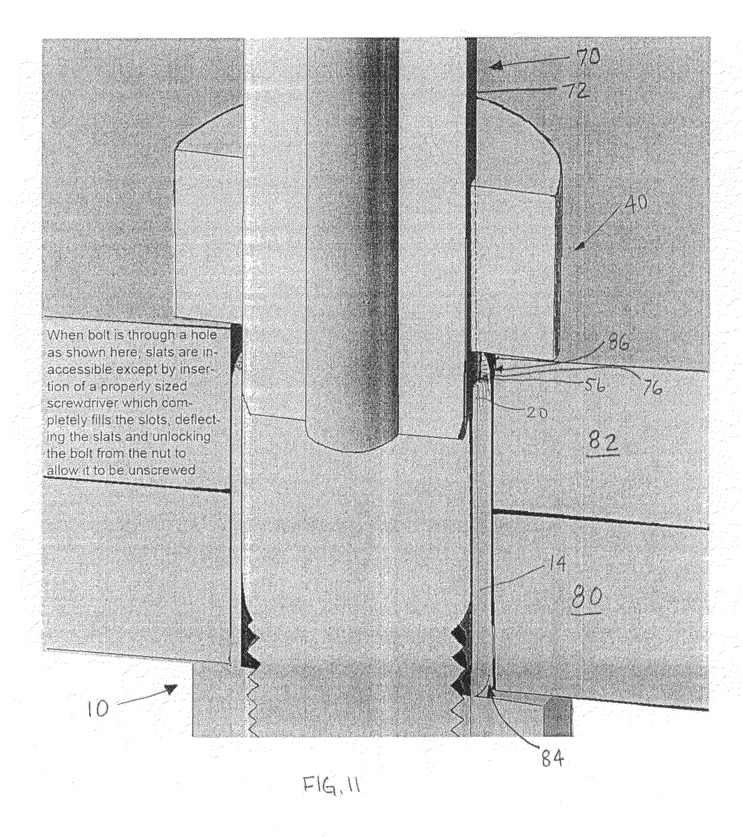

As shown in FIG. 11, objects 80 and 82 can be secured together by locking device 10. Object 80 can have an aperture 84 and object 82 can have an aperture 86. Once objects 80 and 82 are placed together and apertures 84 and 86 are aligned, end portion 14 of nut element 12 can be inserted into apertures 84 and 86. Driver head 72 of driver device 70 can be used to engage head aperture 46 of bolt element 40 as described above so that bolt element 40 can be screwed tightly into nut element 12. Once head 72 of driver device 70 is removed, bolt element 40 cannot be disengaged from nut element 12 without the use of a proper driver device that can ensure deflection of slats 20 out of slots 56 thereby unlocking bolt element 40 from nut element 12 to allow such disengagement.

As can be seen in FIG. 11, the points where slots 56 and slats 20 engage reside within the apertures 84, 86 within the objects 80, 82 being held together by locking device 10. In this manner, the locking points where slots 56 and slats 20 engage is hidden within the objects 80, 82 so that the locking points and/or slots 56 are not accessible except through the use of properly sized and shaped driver devices that fit and fill slots 56. Thus, this embodiment provides a means for screwing a threaded nut element to a threaded bolt element so that they will not come unscrewed unless through the use of a specialized driver device. Further, it also provides a “lock and key” type mechanism where someone who wishes to unscrew one of these nut element and bolt element combinations must have a driver device which exactly fits the shape of the slots in the bolt element.

In addition, as described above, the nut element and bolt element may be unthreaded such that the locking device functions without screwing the nut element and bolt element together while still preventing rotation of the bolt element within the nut element and permitting the nut element and bolt element to be held together. Thus, such a locking device can be used as a lock and key mechanism alone without a screwing function. Further, the driver device can extend farther and have a typical tumbler lock key on its end to be used in combination with a traditional tumbler lock. A tumbler lock combined with such a locking device would be more difficult to pick due to the necessity of requiring a correctly shaped driver device base to the key in addition to the serrated portion of the key which align the tumblers for unlocking.

Additionally, locking device 10 employing a threaded nut element and bolt element can provide excellent axle functions as well. When placing a rotating part in a machine, the locking device needs to screw in so that it fits snugly in place. The shaft should not be too tight so as to impede rotation, while being tight enough to firm hold the rotating part to the machine. Locking device 10 that employs nut element 12 with slats 20 and bolt element 40 would allow for fine control as to the tightness by which the rotating part is secured to the machine. Locking device 10 would permit quick insertion and fastening of bolt element 40 to nut element 12 and permit immediate locking of the bolt element 40 and nut element 12 together upon removal of the driver device.

The embodiments of the present disclosure shown in the drawings and described above are exemplary of numerous embodiments that can be made in the scope of the appending claims. It is contemplated that the configurations of the locking devices comprise numerous configurations other then those specifically disclosed. Thus, it is the applicant's intention that the scope of any patent issuing herefrom will only be limited by the scope of the appending claims.

What is claimed is:

1. A locking device comprising:
(a) a nut element having a body portion and an end portion, the end portion having a proximal end proximate to the body portion and a distal end, the nut element having an inner surface defining a nut aperture that extends through the body portion and the end portion;
(b) a bolt element having a head and a body, the head of the bolt element defining a head aperture therein that extends into the body of the bolt element, the body defining at least one slot therein that is in communication with the head aperture; and
(c) one or more slats disposed along the distal end of the end portion of the nut element, the slats configured to engage the at least one slot defined in the body of the bolt element.

2. The locking device of claim 1, wherein the inner surface of the nut element comprises a first section within the end portion of the nut element and a second section within the body portion of the nut element, wherein the first section defines a larger diameter of the nut aperture than a diameter of the nut aperture within the second section.

3. The locking device of claim 2, wherein the second section of the inner surface is threaded.

4. The locking device of claim 1, wherein the end portion of the nut element includes a sleeve between the proximal end and the slats at the distal end, the sleeve having an outer surface.

5. The locking device of claim 4, wherein the outer surface of the sleeve has a cross-sectional shape that matches the cross-sectional shape of apertures into which the end portion of the nut element is inserted.

6. The locking device of claim 1, wherein the body of the bolt element comprises a first segment disposed proximate to the head of the bolt element and a second segment disposed distal from the head of the bolt element.

7. The locking device of claim 6, wherein the at least one slot is defined in the first segment of the body of the bolt element.

8. The locking device of claim 6, wherein the second segment of the body of the bolt element is threaded.

9. The locking device of claim 6, wherein the second segment of the body of the bolt element has a smaller diameter than a diameter of the nut aperture as measured from points of the slats that extend furthest into the nut aperture.

10. The locking device of claim 9, wherein the first segment of the body of the bolt element has a greater diameter than the diameter of the nut aperture as measured from a top of the slats.

11. The locking device of claim 10, wherein the body of the bolt element comprises a sloped surface between second segment and the first segment of the body of the bolt element.

12. The locking device of claim 1, wherein the first segment comprises a lip below the at least one slot configured for receipt of a driver device within the head aperture and the slot.

13. The locking device of claim 1, wherein the slats are slanted inward toward the nut aperture.

14. The locking device of claim 1, wherein the head aperture within the head of the bolt element includes a guide lock entry.

15. The locking device of claim 14, wherein the guide lock entry provides a feature that requires a matching feature on a driver device to permit that engagement of the driver device.

16. A locking device comprising:
(a) a nut element having a body portion and an end portion, the end portion having a proximal end proximate to the body portion and a distal end, the nut element having an inner surface defining a nut aperture that extends through the body portion and the end portion with the inner surface of the nut element being at least partially threaded;
(b) a bolt element having a head and a body, the head of the bolt element defining a head aperture therein that extends into the body of the bolt element and the body of the bolt element being at least partially threaded to matingly engage the threaded inner surface of the nut element, the body defining at least one slot therein that is in communication with the head aperture; and
(c) one or more slats disposed along the distal end of the end portion of the nut element, the slats configured to engage the at least one slot defined in the body of the bolt element.

17. The locking device of claim 16, wherein the inner surface of the nut element comprises a first section within the end portion of the nut element and a second section within the body portion of the nut element, wherein the first section defines a larger diameter of the nut aperture than a diameter of the nut aperture within the second section.

18. The locking device of claim 17, wherein the second section of the inner surface is threaded.

19. The locking device of claim 18, wherein the diameter of the nut aperture as measured from points of the slats that extend furthest into the nut aperture is greater than the diameter of the second section of the inner surface.

20. The locking device of claim 16, wherein the end portion of the nut element includes a sleeve between the proximal end and the slats at the distal end, the sleeve having an outer surface.

21. The locking device of claim 21, wherein the outer surface of the sleeve has a cross-sectional shape that matches the cross-sectional shape of apertures into which the end portion of the nut element is inserted.

22. The locking device of claim 16, wherein the body of the bolt element comprises a first segment disposed proximate to the head of the bolt element and a second segment disposed distal from the head of the bolt element.

23. The locking device of claim 22, wherein the at least one slot is defined in the first segment of the body of the bolt element.

24. The locking device of claim 22, wherein the second segment of the body of the bolt element is threaded.

25. The locking device of claim 22, wherein the second segment of the body of the bolt element has a smaller diameter than a diameter of the nut aperture as measured from points of the slats that extend furthest into the nut aperture.

26. The locking device of claim 25, wherein the first segment of the body of the bolt element has a greater diameter than the diameter of the nut aperture as measured from a top of the slats.

27. The locking device of claim 26, wherein the first segment of the body of the bolt element has a diameter that is about equal to the diameter of the nut aperture within the end portion below the slats.

28. The locking device of claim 26, wherein the body of the bolt element comprises a sloped surface between second segment and the first segment of the body of the bolt element.

29. The locking device of claim 22, wherein the second segment of the body of the bolt element has a smaller diameter than the diameter of the nut aperture as measured from tops of the slats.

30. The locking device of claim 16, wherein the first segment comprises a lip below the at least one slot configured for receipt of a driver device within the head aperture and the slot.

31. The locking device of claim 16, wherein the head aperture within the head of the bolt element includes a guide lock entry.

32. The locking device of claim 31, wherein the guide lock entry provides a feature that requires a matching feature on a driver device to permit that engagement of the driver device.

33. The locking device of claim 16, wherein the at least one slot comprises multiple slots.

34. The locking device of claim 16, wherein the slats are slanted inward toward the nut aperture.

35. The locking device of claim 16, wherein the slats have a width such that at least one slat engages the at least one slot defined in the body of the bolt element after engagement of the bolt element within the nut element and removal of a driver device from the head aperture and the at least one slot.

36. A locking device comprising:
(a) a nut having a body portion and an end portion, the end portion having a proximal end proximate to the body portion and a distal end;
(b) an inner surface disposed within the nut and defining a nut aperture that extends through the body portion and the end portion, the inner surface of the nut comprising a first section within the end portion of the nut and a second section within the body portion of the nut that is at least partially threaded, wherein a diameter of the nut aperture as measured in the first section is greater than a diameter of the nut aperture within the second section;
(c) a bolt having a head and a body, the head of the bolt defining a head aperture therein that extends into the body of the bolt and the body of the bolt comprising a first segment disposed proximate to the head of the bolt and a second segment disposed distal from the head of the bolt with the second segment being at least partially threaded to matingly engage the threaded inner surface of the nut, the first segment of the body of the bolt having a diameter that is about equal to the diameter of the nut aperture within the first section of the inner surface and the second segment of the body of the bolt having a diameter that is about equal to the diameter of the nut aperture within the second section of the inner surface, the body defining at least one slot therein that is in communication with the head aperture; and
(d) a plurality of slats disposed along the distal end of the end portion of the nut, the slats configured to engage the at least one slot defined in the body of the bolt.

37. The locking device of claim 36, wherein a diameter of the nut aperture as measured from a top of the slats is greater than the diameter of the second section of the inner surface and the diameter of the second segment of the body of the bolt.

38. The locking device of claim 36, wherein the at least one slot is defined in the first segment of the body of the bolt.

39. The locking device of claim 38, wherein the first segment comprises a lip below the at least one slot configured for receipt of a driver device within the head aperture and the slot.

40. The locking device of claim 36, wherein the body of the bolt comprises a sloped surface between second segment and the first segment of the body of the bolt.

41. The locking device of claim 36, wherein the head aperture within the head of the bolt includes a guide lock entry.

42. The locking device of claim 41, wherein the guide lock entry provides a feature that requires a matching feature on a driver device to permit that engagement of the driver device.

43. The locking device of claim 36, wherein the at least one slot comprises multiple slots.

44. The locking device of claim 36, wherein the slats are slanted inward toward the nut aperture.
